(19) United States
(12) Patent Application Publication
(10) Pub. No.: US 2007/0172626 A1
(43) Pub. Date: Jul. 26, 2007

(54) OPTICAL RECORDING MEDIUM AND METHOD FOR PRODUCING THE SAME

(75) Inventor: Tomoyoshi Ichikawa, Miyagi (JP)

Correspondence Address: BELL, BOYD & LLOYD, LLP, P. O. BOX 1135, CHICAGO, IL, 60690, US

(73) Assignee: C/O SONY CORPORATION, Tokyo (JP)

(21) Appl. No.: 11/627,254

(22) Filed: Jan. 25, 2007

(30) Foreign Application Priority Data
Jan. 26, 2006 (JP) 2006-017987

(51) Int. Cl. B32B 3/02

(52) U.S. Cl. 428/64.4

(57) ABSTRACT

An optical recording medium and method for producing same are provided. The optical recording medium includes at least an upper dielectric layer, a recording layer, a lower dielectric layer, a sulfide-stain preventing layer, and a reflective layer formed on a substrate in this order in the direction of incidence of a recording or reading laser, wherein the recording layer contains a material represented by the following general formula: GaₓSn_{y}Ge_{z}Sb_{w}, wherein 0≦x≦7, 13≦y≦20, and 0.08≦z/w≦0.2, wherein the lower dielectric layer contains a composite material of zinc sulfide and silicon oxide and has a thickness of 1 to 6 nm, and wherein the reflective layer contains an Ag alloy and has a thickness of 160 nm or more.

### CROSS REFERENCES TO RELATED APPLICATIONS

The present application claims priority to Japanese Patent Application JP 2006-017987 filed in the Japanese Patent Office on Jan. 26, 2006, the entire contents of which is being incorporated herein by reference.

### BACKGROUND

The present application relates to an optical recording medium and a method for producing the same. More particularly, the present application is concerned with an optical recording medium on which a data signal is recorded or erased utilizing a phase change between an amorphous phase and a crystalline phase.

In the recording of information with a higher density and an increased capacity, an optical recording medium is promising. According to the use, the optical recording medium is roughly classified into three types, i.e., a read only type, a write-once read many type, and a rewritable type, and, of these, a rewritable type optical recording medium is the most promising since the data recorded on this medium can be erased and rewritten. As a representative example of the rewritable type optical recording medium, there can be mentioned a phase change type optical recording medium.

FIGS. 7 to 9 show the constructions of conventional phase change type optical recording media. A phase change type optical recording medium 110 shown in FIG. 7 includes, generally, on a first substrate 111 composed of polycarbonate, an upper dielectric layer 112, a recording layer 113 composed of a phase change material, a lower dielectric layer 114, and a reflective layer 115 which are stacked on one another, and a second substrate 117 further stacked thereon through a protective layer (bonding layer) 116. In the phase change type optical recording medium 110 having this construction, the recording layer 113 is irradiated with a laser beam from the side of the first substrate 111, and, according to the pulse power and pulse width of the laser beam, the irradiated potion is allowed to undergo reversible transfer in the phase state or phase transition between, for example, a crystalline state and an amorphous state, thus achieving data recording or erasing.

A phase change type optical recording medium 110 shown in FIG. 8 includes, generally, on a substrate 117 composed of polycarbonate, a reflective layer 115, a lower dielectric layer 114, a recording layer 113 composed of a phase change material, an upper dielectric layer 112, and a light transmitting layer 121 which are stacked on one another. In the phase change type optical recording medium 110 having this construction, the recording layer 113 is irradiated with a laser beam from the side of the light transmitting layer 121, and, according to the pulse power and pulse width of the laser beam, the irradiated potion is allowed to undergo reversible transfer in the phase state or phase transition between, for example, a crystalline state and an amorphous state, thus achieving data recording or erasing.

A phase change type optical recording medium 110 shown in FIG. 9 includes, generally, on a substrate 111 composed of polycarbonate, an upper dielectric layer 112, a recording layer 113 composed of a phase change material, a lower dielectric layer 114, a reflective layer 115, and a protective layer 122 which are stacked on one another. In the phase change type optical recording medium 110 having this construction, the recording layer 113 is irradiated with a laser beam from the side of the substrate 111, and, according to the pulse power and pulse width of the laser beam, the irradiated potion is allowed to undergo reversible transfer in the phase state or phase transition between, for example, a crystalline state and an amorphous state, thus achieving data recording or erasing.

In recent years, as the amount of data to be recorded increases, the development of an optical recording medium that can achieve recording, erasing, and reading data at a much higher speed is desired. For meeting the demands, a phase change recording material capable of being crystallized at a further higher speed must be used in the recording layer in the medium.

Conventionally, as a material for the recording layer, chalcogen alloys have been widely used. Examples of chalcogen alloys include GeSbTe, InSbTe, GeSnTe, and AgInSbTe alloys. Among these alloys, when using in the recording layer a material having an Sb70Te30 eutectic composition, composed mainly of an Sb70Te30 alloy containing an excess amount of Sb, there can be obtained an optical recording medium improved in crystallization speed to achieve repeated recording (overwrite) at a high speed. In practical uses, for improving the storage durability, controlling the crystallization speed, or improving the modulation degree, as an additive element, a slight amount of Ge, Ag, or In is added to the Sb70Te30 alloy.

Further, increasing the crystallization speed by controlling the composition of the recording layer has been proposed. For example, with respect to the above-mentioned material having an Sb70Te30 eutectic composition, when the Sb/Te ratio is increased and the amount of the additive element is optionally controlled, the material can be crystallized at a high speed, thus making it possible to achieve repeated recording at a speed up to about 4 times the speed of a digital versatile disc (DVD). Refer to Japanese Patent Application Publication No. 2001-344808. However, when the Sb/Te ratio is increased to further improve the repeated recording speed, a problem occurs in that the storage stability of the amorphous mark is lowered. For making up for the lowered storage stability of the amorphous mark, an additive element can be added to improve the storage stability; however, the excess additive element lowers the signal properties. In other words, it is difficult to achieve both high-speed recording and excellent storage stability. Particularly, when using the above material having an Sb70Te30 eutectic composition in the repeated recording at a speed 8 times the speed of a DVD (8×, 28 m/s), it is extremely difficult to achieve both excellent overwrite properties and excellent storage stability of the recording mark (hereinafter, referred to as “archival properties”). For solving the problem, an optical recording medium using a recording layer material having a Ga12Sb88 eutectic composition and containing an additive element, such as Ge, Sn, or In, has been proposed. Refer to Japanese Patent Application Publication No. 2005-22407.

As mentioned above, by using the recording layer material having a Ga12Sb88 eutectic composition, the resultant optical recording medium can achieve both excellent overwrite properties and excellent storage stability of the recording mark (archival properties). However, the crystalline phase in the recording layer is lowered in reflectance after the long-term storage, causing a problem in that the recording-reading properties after the storage (hereinafter, referred to as “shelf properties”) become poor. Therefore, it is desired that the optical recording medium achieves both excellent overwrite properties at a high speed and excellent storage reliability (archival properties and shelf properties).

### SUMMARY

In an embodiment, an optical recording medium which is advantageous in that it achieves both excellent overwrite properties at a high speed and excellent storage reliability, and a method for producing the same are provided.

For achieving the above task, according to an embodiment, there is provided an optical recording medium which includes at least an upper dielectric layer, a recording layer, a lower dielectric layer, a sulfide-stain preventing layer, and a reflective layer formed on a substrate in this order in the direction of incidence of a recording or reading laser,

wherein the recording layer is composed of a material represented by the following general formula:

GaxSnyGezSbw

wherein 0≦x≦7, 13≦y≦20, and 0.08≦z/w≦0.2,

wherein the lower dielectric layer is composed of a composite material of zinc sulfide and silicon oxide and has a thickness of 1 to 6 nm,

wherein the reflective layer is composed of an Ag alloy and has a thickness of 160 nm or more.

According to another embodiment, there is provided a method for producing an optical recording medium which includes at least an upper dielectric layer, a recording layer, a lower dielectric layer, a sulfide-stain preventing layer, and a reflective layer formed on a substrate in this order in the direction of incidence of a recording or reading laser, the method including the steps of:

forming the recording layer composed of GaxSnyGezSbw (wherein 0≦x≦7, 13≦y≦20, and 0.08≦z/w≦0.2);

forming the lower dielectric layer, composed of a composite material of zinc sulfide and silicon oxide, having a thickness of 1 to 6 nm; and

forming the reflective layer, composed of an Ag alloy, having a thickness of 160 nm or more.

In an embodiment, it is preferred that the recording layer has a thickness in the range of from 12 to 18 nm. It is preferred that a Ta oxide layer is further formed so that it is in contact with the surface of the recording layer on the side of incidence of a laser beam. When the Ta oxide layer is formed, it is preferred that the Ta oxide layer has a thickness in the range of from 1 to 4 nm. It is preferred that the sulfide-stain preventing layer is composed of silicon nitride and in contact with the reflective layer.

In an embodiment, the recording layer is composed of GaxSnyGezSbw (wherein 0≦x≦7, 13≦y≦20, and 0.08≦z/w≦0.2), the lower dielectric layer is composed of a composite material of zinc sulfide and silicon oxide and has a thickness of 1 to 6 nm, and the reflective layer is composed of an Ag alloy and has a thickness of 160 nm or more. Therefore, the optical recording medium can achieve both excellent overwrite properties at a high speed and excellent shelf properties and archival properties.

As described above, there can be provided an optical recording medium which is advantageous in that it achieves both excellent overwrite properties at a high speed and excellent storage reliability.

Additional features and advantages are described herein, and will be apparent from, the following Detailed Description and the figures.

### BRIEF DESCRIPTION OF THE FIGURES

FIG. 1 is a cross-sectional view showing one example of the construction of the optical recording medium according to an embodiment.

FIG. 2 is a diagrammatic view showing the construction of a sputtering system used in production of the optical recording medium according to an embodiment.

FIG. 3 is a diagrammatic view showing one example of the construction of a formatting system used in the formatting treatment.

FIG. 4 is a cross-sectional view showing one example of the construction of the optical recording medium according to an embodiment.

FIG. 5 is a cross-sectional view showing one example of the construction of the optical recording medium according to an embodiment.

FIG. 6 is a cross-sectional view showing one example of the construction of the optical recording medium according to an embodiment.

FIG. 7 is a cross-sectional view showing the construction of a conventional phase change type optical recording medium.

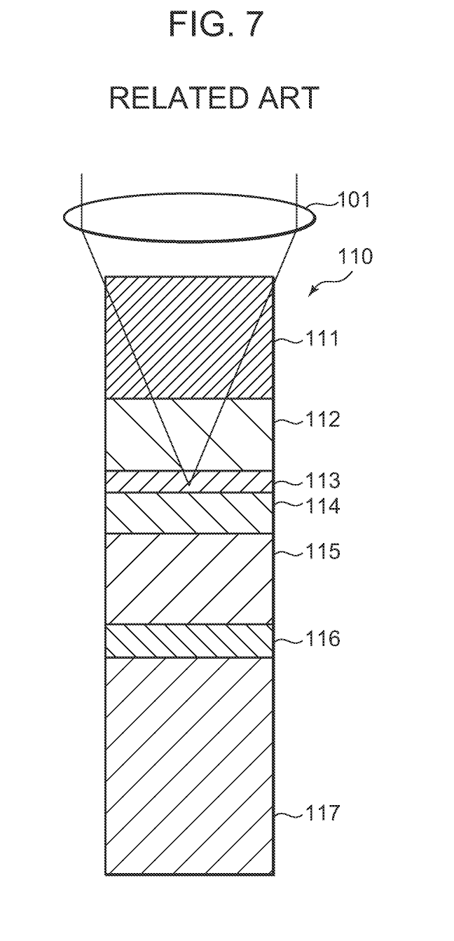

FIG. 8 is a cross-sectional view showing the construction of another conventional phase change type optical recording medium.

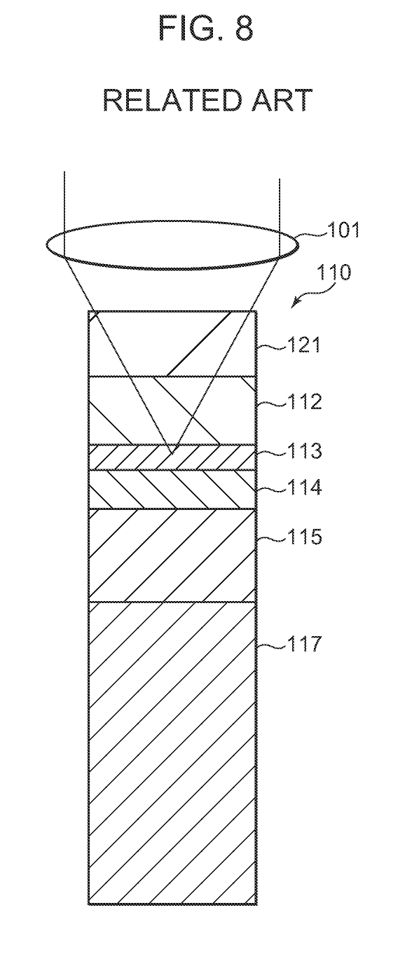

FIG. 9 is a cross-sectional view showing the construction of still another conventional phase change type optical recording medium.

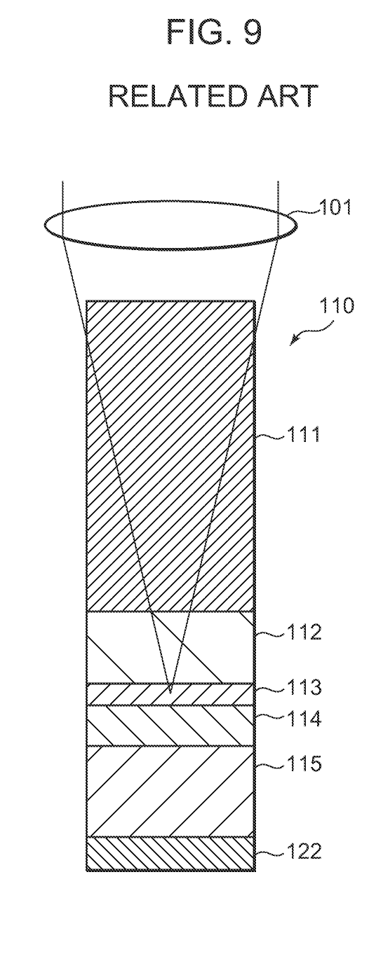

### DETAILED DESCRIPTION

Embodiments will be described with reference to the accompanying drawings. In the drawings, like parts or portions are indicated by like reference numerals.

### (1) First Embodiment

(1-1) Construction of Optical Recording Medium

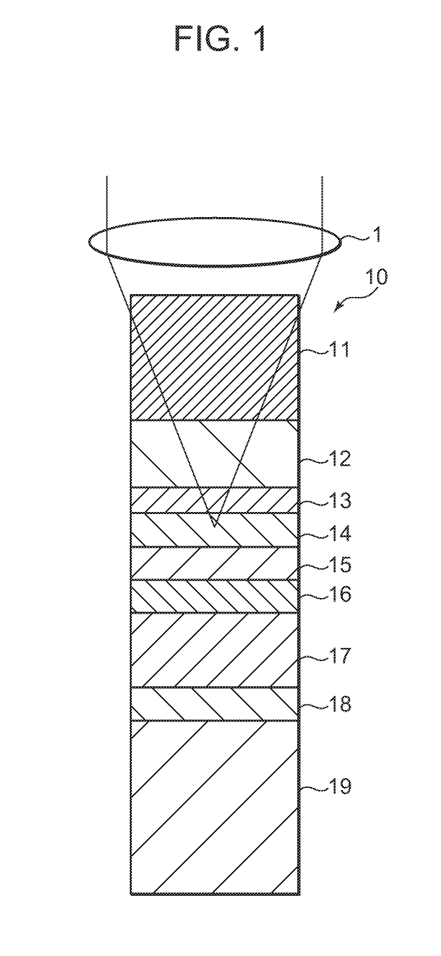

FIG. 1 is a cross-sectional view showing one example of the construction of the optical recording medium according to the first embodiment. As shown in FIG. 1, the optical recording medium 10 has a construction such that, on one principal surface of a first substrate 11, an upper dielectric layer 12, an interface layer 13, a recording layer 14 as a phase change recording layer, a lower dielectric layer 15, a sulfide-stain preventing layer (barrier layer) 16, and a reflective layer (heat diffusion layer) 17 are stacked on one another, and a second substrate 19 is further stacked through a protective layer (bonding layer) 18.

In the optical recording medium 10, the recording layer 14 is irradiated with a laser beam from the side of the first substrate 11, thus achieving data signal recording or reading. A laser beam having, e.g., a wavelength of 650 to 665 nm is focused with an objective lens 1 having a numerical aperture of 0.64 to 0.66, and the recording layer 14 is irradiated with the focused laser from the side of the first substrate 11, thus achieving data signal recording or reading.

Hereinbelow, the first substrate 11, second substrate 19, upper dielectric layer 12, interface layer 13, recording layer 14, lower dielectric layer 15, sulfide-stain preventing layer 16, reflective layer 17, and protective layer 18 constituting the optical recording medium 10 according to the first embodiment are individually described.

[Substrate]

The first substrate 11 and second substrate 19 individually have a doughnut shape having a center hole (not shown) formed in the center, and each of the first substrate 11 and the second substrate 19 has a thickness selected of, for example, 0.6 mm. In the surface of the first substrate 11 on which the recording layer 14 is formed, an uneven pattern called land or groove is formed. For example, an optical spot can be moved along the groove as a guide to an arbitrary position on the optical recording medium 10. As a form of the uneven pattern, various forms, such as a spiral form, a concentric form, and a pit row, can be used.

As a material for the first substrate 11 or second substrate 19, a plastic material, such as a polycarbonate resin, a polyolefin resin, or an acrylic resin, is advantageously used from the viewpoint of reducing the cost, or glass can be used. As a method for forming the first substrate 11 or second substrate 19, for example, an injection molding method or a photopolymer method (2P method) using an ultraviolet curing resin can be used. Alternatively, any other methods can be used as long as a substrate having a desired form and an optically satisfactory smooth surface can be obtained.

[Upper Dielectric Layer]

As a material for the upper dielectric layer 12, a material having no absorptive power to the wavelength of a recording or reading laser is desired, specifically, a material having a linear attenuation coefficient k of 0.3 or less is preferred. Examples of such materials include ZnS—SiO2 composite materials (especially, molar ratio: about 4:1). In addition to the ZnS—SiO2 composite materials, any materials conventionally used in optical recording media can be used in the upper dielectric layer 12.

For example, a layer composed of or a layer composed mainly of a nitride, an oxide, a carbide, a fluoride, a sulfide, a nitride-oxide, a nitride-carbide, or an oxide-carbide of an element of metal or semi-metal, such as Al, Si, Ta, Ti, Zr, Nb, Mg, B, Zn, Pb, Ca, La, or Ge, can be used. Specific examples include AlNx (0.5≦x≦1), especially AlN, Al2O3-x (0≦x≦1), especially Al2O3, Si3N4-x (0≦x≦1), especially Si3N4, SiOx (1≦x≦2), especially SiO2, SiO, MgO, Y2O3, MgAl2O4, TiOx (1≦x≦2), especially TiO2, BaTiO3, SrTiO3, Ta2O5-x (0≦x≦1), especially Ta2O5, GeOx (1≦x≦2), SiC, ZnS, PbS, Ge—N, Ge—N—O, Si—N—O, CaF2, LaF, MgF2, NaF, and ThF4. A layer composed of or a layer composed mainly of the above material can be used. Alternatively, a layer composed of a mixture of the above materials, for example, AlN—SiO2 can be used in the upper dielectric layer 12.

The upper dielectric layer 12 preferably has a thickness selected in the range of from 50 to 250 nm, for example, about 77 nm.

[Interface Layer]

As a material for the interface layer 13, for example, Ta2O5 can be used. By virtue of the interface layer 13, the overwrite properties can be improved

The interface layer 13 preferably has a thickness selected in the range of from 1 to 7 nm. When the interface layer 13 has a thickness of less than 1 nm, it is difficult to form a uniform layer. On the other hand, when the interface layer 13 has a thickness of more than 7 nm, the modulation degree is lowered, so that the recording properties become poor.

[Recording Layer]

As a material for the recording layer 14, a material which undergoes a reversible change in state due to irradiation with a laser beam, i.e., a phase change material can be used. As the phase change material, preferred is a material which undergoes a reversible phase change between an amorphous state and a crystalline state, and, for example, a material of a chalcogen compound or chalcogen as a simple substance, specifically, GaSnGeSb is used.

It is preferred that the Ga content of the recording layer material is in the range of from 0 to 7 at %. When the Ga content is larger than 7 at %, the crystalline phase is lowered in reflectance after the long-term storage, so that the shelf properties (recording-reading properties after the storage) become poor.

It is preferred that the Sn content of the recording layer material is in the range of from 13 to 20 at %. When the Sn content is smaller than 13 at %, the crystallization speed is lowered, making it difficult to obtain satisfactory overwrite properties. On the other hand, when the Sn content is larger than 20 at %, the crystallization speed is too fast to form a recording mark, so that the recording properties become poor.

It is preferred that the Ge/Sb ratio in the recording layer material is in the range of from 0.08 to 0.2. When the Ge/Sb ratio is smaller than 0.08, the crystallization speed is too fast to form a recording mark, so that the recording properties become poor. On the other hand, when the Ge/Sb ratio is larger than 0.2, the crystallization speed is lowered, making it difficult to obtain satisfactory overwrite properties.

The recording layer 14 preferably has a thickness in the range of from 12 to 18 nm. When the recording layer 14 has a thickness of less than 12 nm, the recording layer 14 is lowered in light absorptive power and cannot appropriately function as a recording layer. On the other hand, when the recording layer 14 has a thickness of more than 18 nm, the repeated recording durability is lowered.

[Lower Dielectric Layer]

As a material for the lower dielectric layer 15, preferred is a material having excellent adhesion to the recording layer 14 and having high thermal storage effect. Examples of such materials include ZnS—SiO2 composite materials (especially, molar ratio: about 4:1).

The lower dielectric layer 15 preferably has a thickness selected in the range of from 1 to 6 nm, for example, about 4 nm. When the lower dielectric layer 15 has a thickness of less than 1 nm, a satisfactory thermal storage effect cannot be obtained, lowering the recording properties. On the other hand, when the lower dielectric layer 15 has a thickness of more than 6 nm, the properties in twice recording after the storage, i.e., shelf DOW (direct over write) 1 properties become poor.

[Sulfide-Stain Preventing Layer]

When the lower dielectric layer 15 is composed of a ZnS—SiO2 composite material and the reflective layer 17 is composed of an Ag alloy, silver (Ag) and sulfur (S) are reacted to each other to cause corrosion. Therefore, as a material for the sulfide-stain preventing layer 16, a material having excellent corrosion resistance such that the above corrosion can be prevented and containing no sulfur is selected. As the material, for example, SiN is selected.

The sulfide-stain preventing layer 16 preferably has a thickness selected in the range of from 5 to 14 nm, for example, about 10 nm.

[Reflective Layer]

As a material for the reflective layer 17, an Ag alloy having a high thermal conductivity is preferred. Examples of such Ag alloys include Ag—Pd—Cu, Ag—Pd—Ti, Ag—In, Ag—Sn—In, and Ag—Nd—Cu.

The reflective layer 17 preferably has a thickness of 160 nm or more, more preferably in the range of from 160 to 300 nm. When the reflective layer 17 has a thickness of less than 160 nm, the properties in twice recording after the storage, i.e., shelf DOW 1 properties become poor. On the other hand, when the reflective layer 17 has a thickness of more than 300 nm, the formation of the film requires a prolonged time, lowering the productivity.

[Protective Layer]

The protective layer 18 is a bonding layer for bonding the first substrate 11 having stacked thereon the upper dielectric layer 12, interface layer 13, recording layer 14, lower dielectric layer 15, sulfide-stain preventing layer 16, and reflective layer 17 to the second substrate 19. The protective layer 18 is formed by curing, for example, an ultraviolet curing resin.

(1-2) Method for Producing Optical Recording Medium

Next, the method for producing the optical recording medium according to the first embodiment is described.

A sputtering system used in production of the optical recording medium 10 according to the first embodiment is first described. This sputtering system is a sheet-fed facing target sputtering system capable of rotating the substrate.

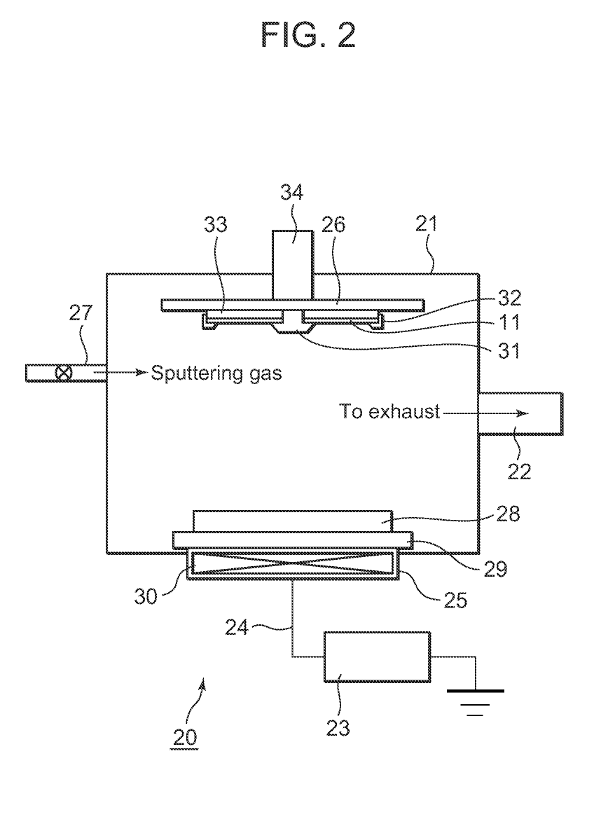

FIG. 2 is a diagrammatic view showing the construction of a sputtering system used in production of the optical recording medium 10. As shown in FIG. 2, the sputtering system 20 includes a vacuum chamber 21 as a film forming chamber, a vacuum controller 22 for controlling the vacuum state in the vacuum chamber 21, a high-voltage DC power supply 23 for plasma discharge, a sputtering cathode portion 25 connected to the high-voltage DC power supply 23 for plasma discharge through a power supply line 24, a pallet 26 disposed opposite the sputtering cathode portion 25 at a predetermined distance, and a sputtering gas feeding portion 27 for feeding sputtering gas including inert gas, such as Ar gas, and reactive gas into the vacuum chamber 21.

The sputtering cathode portion 25 has a target 28 which serves as a negative electrode, a backing plate 29 which is constructed for fixing the target 28, and a magnet system 30 formed on the surface of the backing plate 29 opposite the surface onto which the target 28 is fixed.

The pallet 26 which serves as a positive electrode and the target 28 which serves as a negative electrode constitute a pair of electrodes. The first substrate 11, which is a substrate on which a film will be formed, is placed on the pallet 26 through a disc base 33 so that the substrate faces the sputtering cathode portion 25. In this instance, the inner periphery and outer periphery of the first substrate 11 are respectively covered with an inner mask 31 and an outer mask 32.

On the side of the pallet 26 opposite the side on which the disc base 33 is placed, a substrate rotation driving portion 34 for rotating the pallet 26 in the in-plane direction of the first substrate 11 is provided.

The sputtering system 20 used in productions of the optical recording medium 10 has the above-described construction. In the following production process, the sputtering systems used in formation of the individual layers have the same construction, and therefore the same reference numerals for constituents as those used in the above-described sputtering system 20 are used.

[Step for Forming Upper Dielectric Layer]

The first substrate 11 is first placed in the sputtering system 20 having set a target 28 composed of, e.g., a ZnS—SiO2 composite material, and fixed to the pallet 26. Then, the vacuum chamber 21 is drawn to a predetermined pressure. Subsequently, inert gas, such as Ar gas, is introduced into the vacuum chamber 21, and sputtering is conducted to form an upper dielectric layer 12 composed of, e.g., a ZnS—SiO2 composite material on the first substrate 11.

An example of the deposition conditions in this sputtering process are shown below.

Degree of vacuum: 5.0×10-5 Pa

Atmosphere: 0.1 to 0.6 Pa

Power: 1 to 3 kW

[Step for Forming Interface Layer]

Next, the first substrate 11 is placed in the sputtering system 20 having set a target 28 composed of, e.g., Ta, and fixed to the pallet 26. Then, the vacuum chamber 21 is drawn to a predetermined pressure. Subsequently, inert gas, such as Ar gas, and oxygen gas (O2) are introduced into the vacuum chamber 21, and sputtering is conducted to form an interface layer 13 composed of, e.g., Ta2O5 on the upper dielectric layer 12.

An example of the deposition conditions in this sputtering process are shown below.

Degree of vacuum: 5.0×10-5 Pa

Atmosphere: 0.1 to 0.6 Pa

Power: 1 to 3 kW

Oxygen gas flow rate: 30 sccm

[Step for Forming Recording Layer]

Next, the first substrate 11 is placed in the sputtering system 20 having set a target 28 composed of, e.g., GaxSnyGezSbw (wherein 0≦x≦7, 13≦y≦20, and 0.08≦z/w≦0.2), and fixed to the pallet 26.

Then, the vacuum chamber 21 is drawn to a predetermined pressure. Subsequently, inert gas, such as Ar gas, is introduced into the vacuum chamber 21, and sputtering is conducted to form a recording layer 14 composed of, e.g., GaxSnyGezSbw (wherein 0≦x≦7, 13≦y≦20, and 0.08≦z/w≦0.2) on the interface layer 13.

An example of the deposition conditions in this sputtering process are shown below.

Degree of vacuum: 5.0×10-5 Pa

Atmosphere: 0.1 to 0.6 Pa

Power: 1 to 3 kW

[Step for Forming Lower Dielectric Layer]

Next, the first substrate 11 is placed in the sputtering system 20 having set a target 28 composed of, e.g., a ZnS—SiO2 composite material, and fixed to the pallet 26. Then, the vacuum chamber 21 is drawn to a predetermined pressure. Subsequently, inert gas, such as Ar gas, is introduced into the vacuum chamber 21, and sputtering is conducted to form a lower dielectric layer 15 composed of, e.g., a ZnS—SiO2 composite material on the recording layer 14.

An example of the deposition conditions in this sputtering process are shown below.

Degree of vacuum: 5.0×10-5 Pa

Atmosphere: 0.1 to 0.6 Pa

Power: 1 to 3 kW

[Step for Forming Sulfide-Stain Preventing Layer]

Next, the first substrate 11 is placed in the sputtering system 20 having set a target composed of, e.g., Si, and fixed to the pallet 26. Then, the vacuum chamber 21 is drawn to a predetermined pressure. Subsequently, for example, Ar gas and nitrogen gas are introduced into the vacuum chamber 21, and sputtering is conducted to form a sulfide-stain preventing layer 16 composed of, e.g., SiN on the lower dielectric layer 15.

An example of the deposition conditions in this sputtering process are shown below.

Degree of vacuum: 5.0×10-5 Pa

Atmosphere: 0.1 to 0.6 Pa

Power: 1 to 3 kW

Nitrogen gas flow rate: 30 sccm

[Step for Forming Reflective Layer]

Next, the first substrate 11 is placed in the sputtering system 20 having set a target 28 composed of, e.g., AgM (M: additive), and fixed to the pallet 26. Then, the vacuum chamber 21 is drawn to a predetermined pressure. Subsequently, for example, Ar gas is introduced into the vacuum chamber 21, and sputtering is conducted to form a reflective layer 17 composed of, e.g., an Ag alloy on the sulfide-stain preventing layer 16.

An example of the deposition conditions in this sputtering process are shown below.

Degree of vacuum: 5.0×10-5 Pa

Atmosphere: 0.1 to 0.6 Pa

Power: 1 to 3 kW

[Step for Bonding Substrates]

Next, the first substrate 11 is removed from the sputtering system, and placed on a predetermined position of, for example, a spin coater, and an ultraviolet curing resin is uniformly applied to the reflective layer 17 by spin coating. Then, the second substrate 19 is stacked on the surface of the first substrate 11 onto which the ultraviolet curing resin is applied. Then, the ultraviolet curing resin is appropriately adjusted in thickness, and irradiated with ultraviolet light, for example, from the side of the second substrate 19 to cure the ultraviolet curing resin, bonding the first substrate 11 and the second substrate 19 together and forming a protective layer 18, thus obtaining a desired optical recording medium 10 according to the first embodiment.

[Formatting Step]

Next, the thus obtained optical recording medium 10 is subjected to formatting treatment. A formatting system used in the formatting treatment is first described.

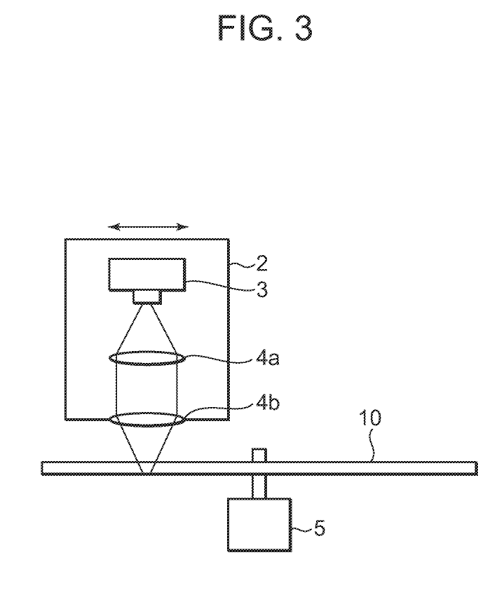

FIG. 3 is a diagrammatic view showing one example of the construction of a formatting system used in the formatting treatment. As shown in FIG. 3, the formatting system includes a laser head 2 for emitting a laser beam, a spindle motor 5 for rotating the optical recording medium 10, and a carriage (not shown) for moving the laser head 2 in the radial direction of the optical recording medium 10. The laser head 2 includes a semiconductor laser 3 having high power and a large aperture, and optical lenses 4a, 4b for adjusting a laser beam emitted from the semiconductor laser 3 to form an appropriate spot on the optical recording medium 10. As a semiconductor laser, for example, an Ar laser can be used.

Using the formatting system having the above-mentioned construction, the whole surface of the optical recording medium 10 is irradiated with a laser beam to crystallize the recording layer 14. For example, while rotating the optical recording medium 10 at a constant linear speed, the surface of the medium on the side of the first substrate 11 is irradiated with a laser spot light flux of about 50 to 300×1 μm formed from a laser beam emitted from the semiconductor laser 3 at an output power of about 2 to 4 W, wherein the laser spot light flux is moved in the radial direction under conditions such that the feed rate is about 20 to 250 μm/feed.

Thus, the optical recording medium 10 is irradiated with a laser beam at areas in both the circumferential direction and the radial direction. With respect to each of the linear speed and the output power Pw, an optimum value is selected according to the capability of the formatting system and the film structure and signal properties of the optical recording medium 10. Further, an optimum feed rate is selected according to the relationship between the laser spot diameter and the treatment time.

Depending on the formatting conditions, the crystalline state of the recording layer 14 varies, and thus the reflectance and the repeated recording properties, especially the jitter in twice recording (DOW 1) vary. When the formatting is conducted at a low power density, the reflectance is likely to be relatively low, and, when the formatting is conducted at a high power density, the reflectance is likely to be relatively high. Even when different reflectances are obtained immediately after the formatting, any reflectances are changed to a certain reflectance as the recording is performed repeatedly. When the reflectance immediately after the formatting is at a low level, a difference in the reflectance between the unrecorded portion and the space portion (crystalline portion) of the recorded portion is large, and, when the reflectance immediately after the formatting is at a high level, a difference in the reflectance between the unrecorded portion and the space portion of the recorded portion is small. The initial crystalline state of the recording layer 14 which suppresses the increase of the jitter in DOW 1 varies depending on the material for the recording layer 14, and some materials having a relatively low reflectance suppress the increase of the jitter in DOW 1, and other materials having a relatively high reflectance suppress the increase of the jitter. In the optical recording medium 10 using the above-mentioned GaxSnyGezSbw (wherein 0≦x≦7, 13≦y≦20, and 0.08≦z/w≦0.2) as a material for the recording layer 14, a relatively high reflectance makes it possible to suppress the increase of the jitter in DOW 1.

### (2) Second Embodiment

In the first embodiment, an example in which the upper dielectric layer is composed of a single layer is described, but, in the second embodiment, an example in which the upper dielectric layer is composed of two dielectric layers is described. In the first and second embodiments, like parts or portions are indicated by like reference numerals.

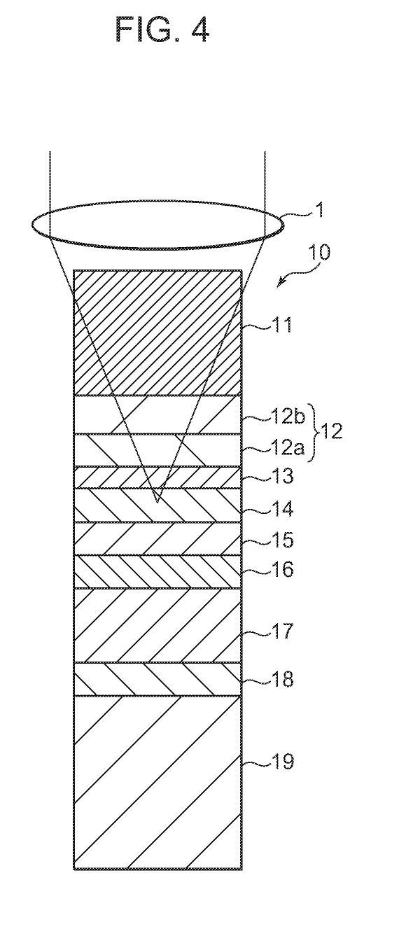

FIG. 4 is a cross-sectional view showing one example of the construction of the optical recording medium according to the second embodiment. The upper dielectric layer 12 includes a second upper dielectric layer 12b and a first upper dielectric layer 12a, which are stacked on one another on the first substrate 11. As a material for the first upper dielectric layer 12a, for example, the same material as that for the lower dielectric layer 15 can be used. As a material for the second upper dielectric layer 12b, for example, the same material as that for the sulfide-stain preventing layer 16 can be used. Except for this, the construction is substantially the same as that of the first embodiment above, and therefore the descriptions are omitted.

### (3) Third Embodiment

In the first embodiment, an example applied to an optical recording medium having stacked layers sandwiched between two substrates is described, but, in the third embodiment, an example applied to an optical recording medium having only one substrate and achieving data signal recording or reading by irradiation of a laser beam from the side opposite the substrate is described. In the first and third embodiments, like parts or portions are indicated by like reference numerals.

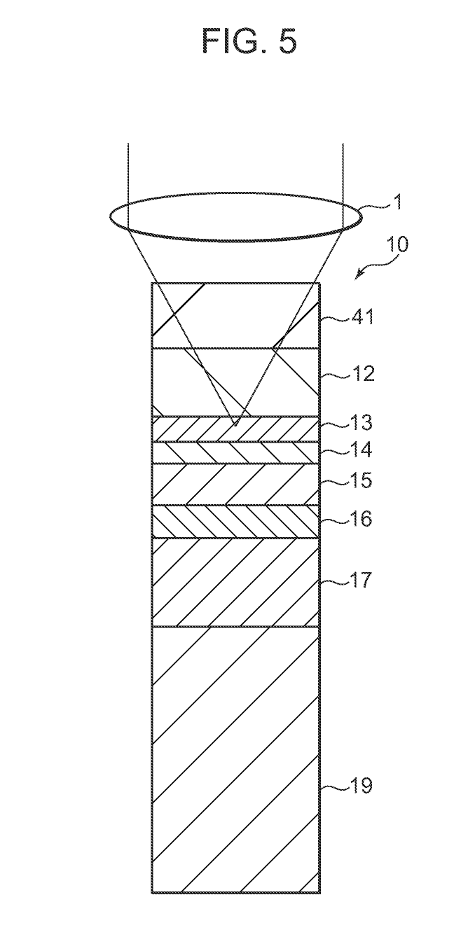

FIG. 5 is a cross-sectional view showing one example of the construction of the optical recording medium according to the third embodiment. As shown in FIG. 5, the optical recording medium 10 has a construction such that, on a substrate 19, a reflective layer 17, a sulfide-stain preventing layer 16, a lower dielectric layer 15, a recording layer 14, an interface layer 13, an upper dielectric layer 12, and a light transmitting layer 41 are stacked on one another. The light transmitting layer 41 can transmit a laser beam for recording or reading a data signal. The light transmitting layer 41 is composed of a light transmitting sheet (film) having, for example, a planar doughnut shape, and a bonding layer for bonding the light transmitting sheet to the substrate 19. The bonding layer is composed of, for example, an ultraviolet curing resin or a pressure sensitive adhesive (PSA). The light transmitting layer 41 has a thickness selected of, for example, 100 μm. The substrate 19 has a thickness selected of, for example, 1.1 mm.

In the optical recording medium 10, the recording layer 14 is irradiated with a laser beam from the side of the light transmitting layer 41, thus achieving data signal recording or reading. A laser beam having, e.g., a wavelength in the range of from 400 to 410 nm is focused with an objective lens 1 having a numerical aperture in the range of from 0.84 to 0.86, and the recording layer 14 is irradiated with the focused laser from the side of the light transmitting layer 41, thus achieving data signal recording or reading. Except for this, the construction is substantially the same as that of the first embodiment above, and therefore the descriptions are omitted.

### (4) Fourth Embodiment

In the fourth embodiment, an example applied to an optical recording medium having only one substrate and achieving data signal recording or reading by irradiation of a laser beam from the substrate side is described. In the first and fourth embodiments, like parts or portions are indicated by like reference numerals.

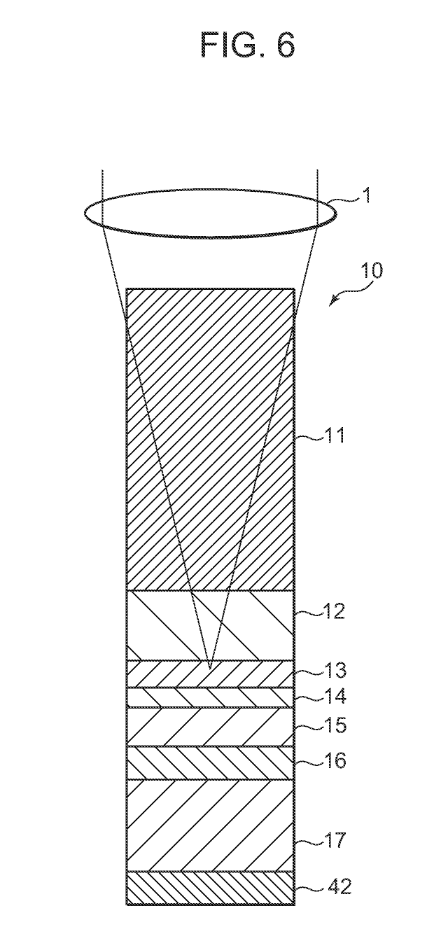

FIG. 6 is a cross-sectional view showing one example of the construction of the optical recording medium according to the fourth embodiment. As shown in FIG. 6, the optical recording medium 10 has a construction such that, on a substrate 11, an upper dielectric layer 12, an interface layer 13, a recording layer 14, a lower dielectric layer 15, a sulfide-stain preventing layer 16, a reflective layer 17, and a protective layer 42 are stacked on one another. The substrate 11 has a thickness selected of, for example, 1.2 mm. The protective layer 42 is formed for protecting the stacked films on the substrate 11, and formed by uniformly applying, for example, an ultraviolet curing resin by a spin coating process and then curing the applied resin by irradiation with ultraviolet light.

In the optical recording medium 10, the recording layer 14 is irradiated with a laser beam from the side of the substrate 11, thus achieving data signal recording and/or reading. A laser beam having, e.g., a wavelength of 775 to 795 nm is focused with an objective lens 1 having a numerical aperture of 0.44 to 0.46, and the recording layer 14 is irradiated with the focused laser from the side of the substrate 11, thus achieving data signal recording or reading. Except for this, the construction is substantially the same as that of the first embodiment above, and therefore the descriptions are omitted.

### EXAMPLES

Hereinbelow, the present application is described in detail with reference to the following Examples, which should not be construed as limiting the scope of the present application.

The compositions of the recording layer materials and the thicknesses of the lower dielectric layers and reflective layers in Examples 1 to 11 and Comparative Examples 1 to 8 are shown in Table 1 below.

TABLE 1

| | Composition of | | | | |
|---|---|---|---|---|---|
| | GaSnGeSb | | | | |
| | film (at %) | | | Thickness (nm) | |
| | Ga | Sn | Ge/Sb | ZnS—SiO₂ Film | Ag Alloy film |
| Example 1 | 5 | 17 | 0.15 | 4 | 200 |
| Example 2 | 0 | 17 | 0.20 | 4 | 200 |
| Example 3 | 3 | 17 | 0.18 | 4 | 200 |
| Example 4 | 7 | 15 | 0.11 | 4 | 200 |
| Example 5 | 5 | 13 | 0.12 | 4 | 200 |
| Example 6 | 5 | 20 | 0.15 | 4 | 200 |
| Example 7 | 5 | 17 | 0.08 | 4 | 200 |
| Example 8 | 5 | 17 | 0.20 | 4 | 200 |
| Example 9 | 5 | 17 | 0.15 | 1 | 200 |
| Example 10 | 5 | 17 | 0.15 | 6 | 200 |
| Example 11 | 5 | 17 | 0.15 | 4 | 160 |
| Comparative | 8 | 13 | 0.08 | 4 | 200 |
| Example 1 | | | | | |
| Comparative | 5 | 12 | 0.15 | 4 | 200 |
| Example 2 | | | | | |
| Comparative | 5 | 21 | 0.16 | 4 | 200 |
| Example 3 | | | | | |
| Comparative | 5 | 17 | 0.07 | 4 | 200 |
| Example 4 | | | | | |
| Comparative | 5 | 17 | 0.22 | 4 | 200 |
| Example 5 | | | | | |
| Comparative | 5 | 17 | 0.15 | 0 | 200 |
| Example 6 | | | | | |
| Comparative | 5 | 17 | 0.15 | 7 | 200 |
| Example 7 | | | | | |
| Comparative | 5 | 17 | 0.15 | 4 | 140 |
| Example 8 | | | | | |

### Examples 1 to 11

A first substrate composed of polycarbonate was first formed by injection molding. The first substrate had a diameter φ of 120 mm and a thickness of 0.6 mm, and a land and a groove and others were transferred to one principal surface of the first substrate by means of a stamper. In addition, the groove was wobbled to add address information.

Then, a ZnS—SiO2 film having a thickness of 77 nm as an upper dielectric layer was formed on the first substrate 11 by a sputtering process. Subsequently, a Ta2O5 film having a thickness of 2 nm as an interface layer was formed on the ZnS—SiO2 film by a sputtering process. Then, a GaSnGeSb film having a thickness of 16 nm as a recording layer was formed on the Ta2O5 film by a sputtering process. The GaSnGeSb films as a recording layer in Examples 1 to 11 had the respective compositions shown in Table 1 above.

Next, a ZnS—SiO2 film as a lower dielectric layer was formed on the GaSnGeSb film by a sputtering process. The ZnS—SiO2 films as a lower dielectric layer in Examples 1 to 11 had the respective thicknesses shown in Table 1 above. Then, an SiN film having a thickness of 10 nm as a sulfide-stain preventing layer (barrier layer) was formed on the ZnS—SiO2 film by a sputtering process. Subsequently, an Ag alloy film as a reflective layer was formed on the SiN film by a sputtering process. The Ag alloy films as a reflective layer in Examples 1 to 11 had the respective thicknesses shown in Table 1 above.

The thickness of each of the layers stacked on the first substrate was determined by appropriately controlling the deposition time according to a calibration curve preliminarily prepared from the relationship between the deposition time and the thickness.

Next, an ultraviolet curing resin was applied by means of a spin coater to the Ag alloy film formed on the first substrate on the film-formed side in an area (outermost periphery) of about 15 to 60 mm from the center of the first substrate, and then a second substrate composed of polycarbonate having a thickness of 0.6 mm was stacked on the first substrate through the ultraviolet curing resin. In this state, the resultant substrate was irradiated with ultraviolet light from the second substrate side using an ultraviolet lamp (UV lamp) for about one second to cure the ultraviolet curing resin, bonding the first substrate and the second substrate together, thus producing a desired optical recording medium.

### Comparative Examples 1 to 8

Optical recording media were individually produced in substantially the same manner as in Example 1 except that GaSnGeSb films as a recording layer, ZnS—SiO2 films as a lower dielectric layer, and Ag alloy films as a reflective layer in Comparative Examples 1 to 8 having the respective compositions or thicknesses shown in Table 1 above were individually formed.

[Evaluation of Overwrite Properties]

The thus obtained optical recording media in Examples 1 to 11 and Comparative Examples 1 to 8 were individually subjected to formatting under the following conditions to crystallize the whole surface.

Laser spot light flux: about 70×1 μm

Feed rate: 34 μm/rotation

Linear speed: 15 m/s

Laser power: 600 mW

Then, the thus formatted optical recording media in Examples 1 to 11 and Comparative Examples 1 to 8 were evaluated with respect to the overwrite properties as follows. In the evaluation of the overwrite properties, Optical disc evaluation apparatus ODU1000, manufactured and sold by Pulstec Industrial Co., Ltd., was used.

A random data signal was first recorded at a linear speed of 28 m/s (8×) on three tracks once (DOW 0), twice (DOW 1), 11 times (DOW 10), or 501 times (DOW 500), and a jitter of the second (middle) track was measured with respect to each number of repeated recording. The recording wave shape was controlled to be optimum for each optical recording medium using the write strategy in accordance with the specification (book) of DVD+RW 8×.

[Evaluation of Storage Reliability]

Next, the optical recording medium, which had achieved DOW 500 overwrite, was evaluated with respect to the storage reliability (archival properties and shelf properties) by the following accelerated test. Specifically, a random data signal was preliminarily recorded on the optical recording medium, and the resultant medium was allowed to stand in an oven heated to 80° C. for 300 hours, followed by measurement of an increase of the jitter (archival properties). On the other hand, the unrecorded medium was allowed to stand in an oven heated to 80° C. for 300 hours, followed by measurement of a jitter in DOW 0 or DOW 1 (shelf properties).

The results of the evaluations of the overwrite properties and storage reliability with respect to the optical recording media in Examples 1 to 11 and Comparative Examples 1 to 8 are shown in Table 2 below. The evaluation results “excellent”, “good”, and “poor” shown in Table 2 are in accordance with the following criteria.

[Evaluation of Overwrite Properties]

excellent: Jitter is 9% or less.

good: Jitter is more than 9 to 12%.

poor: Jitter is more than 12%.

[Archival Properties]

good: Increase of jitter is 1% or less.

poor: Increase of jitter is more than 1%.

[Shelf Properties]

good: Jitter is 12% or less.

poor: Jitter is more than 12%.

TABLE 2

| | Overwrite properties | | | | Storage reliability | | |
|---|---|---|---|---|---|---|---|
| | | | DOW | DOW | | Shelf | Shelf |
| | DOW 0 | DOW 1 | 10 | 500 | Archival | (DOW 0) | (DOW 1) |
| Example 1 | excellent | excellent | excellent | excellent | good | good | good |
| Example 2 | excellent | excellent | excellent | good | good | good | good |
| Example 3 | excellent | good | excellent | excellent | good | good | good |
| Example 4 | excellent | good | good | good | good | good | good |
| Example 5 | excellent | good | good | good | good | good | good |
| Example 6 | good | good | good | good | good | good | good |
| Example 7 | good | good | good | good | good | good | good |
| Example 8 | excellent | good | good | good | good | good | good |
| Example 9 | excellent | excellent | excellent | good | good | good | good |
| Example 10 | excellent | excellent | excellent | excellent | good | good | good |
| Example 11 | excellent | excellent | excellent | excellent | good | good | good |
| Comparative | excellent | excellent | excellent | excellent | good | poor | poor |
| Example 1 | | | | | | | |
| Comparative | excellent | poor | poor | poor | — | — | — |
| Example 2 | | | | | | | |
| Comparative | poor | poor | poor | poor | — | — | — |
| Example 3 | | | | | | | |
| Comparative | poor | poor | poor | poor | — | — | — |
| Example 4 | | | | | | | |
| Comparative | excellent | poor | poor | poor | — | — | — |
| Example 5 | | | | | | | |
| Comparative | excellent | good | good | good | poor | poor | poor |
| Example 6 | | | | | | | |
| Comparative | excellent | excellent | excellent | good | good | good | poor |
| Example 7 | | | | | | | |
| Comparative | excellent | excellent | excellent | excellent | good | good | poor |
| Example 8 | | | | | | | |

From the results of the evaluation shown in Table 2, the following findings are obtained.

In Examples 1 to 11, with respect to the GaSnGeSb film, the Ga content is in the range of from 0 to 7 at %, the Sn content is in the range of from 13 to 20 at %, and the Ge/Sb ratio is in the range of from 0.08 to 0.2, and the ZnS—SiO2 film has a thickness in the range of from 1 to 6 nm and the Ag alloy film has a thickness of 160 nm or more. Therefore, 8× overwrite was possible up to 501 times of recording, and the archival properties and shelf properties were excellent.

By contrast, in Comparative Example 1, 8× overwrite was possible up to 501 times of recording and the archival properties were excellent, but the Ga content is more than 7 at % and therefore the shelf DOW 0 properties and shelf DOW 1 properties were unsatisfactory. In Comparative Examples 2 and 3, the Sn content is less than 13 or more than 20, and therefore the 8× overwrite properties were unsatisfactory. In Comparative Examples 4 and 5, the Ge/Sb ratio is less than 0.08 or more than 0.20, and therefore the 8× overwrite properties were unsatisfactory. In Comparative Example 6, 8× overwrite was possible up to 501 times of recording, but no ZnS—SiO2 film as a lower dielectric layer was formed and hence peeling occurred between the GaSnGeSb film and the SiN film after the storage, and therefore the storage reliability was unsatisfactory. In Comparative Examples 7 and 8, 8× overwrite was possible up to 501 times of recording and the archival properties and shelf DOW 0 properties were excellent, but the Ag alloy film has a thickness of less than 160 nm and therefore the shelf DOW 1 properties were unsatisfactory.

The thicknesses of the interface layers in Examples 12 to 15 and Comparative Example 9 and the results of the evaluation of the overwrite properties are shown in Table 3 below.

TABLE 3

| | Thickness | | | | |
|---|---|---|---|---|---|
| | (nm) | | | | |
| | Ta₂O₅ | Overwrite properties | | | |
| | Film | DOW 0 | DOW 1 | DOW 10 | DOW 500 |
| Example 12 | 0 | excellent | good | excellent | good |
| Example 13 | 1 | excellent | excellent | excellent | excellent |
| Example 14 | 4 | excellent | excellent | excellent | excellent |
| Example 15 | 7 | good | good | good | good |
| Comparative | 9 | good | poor | good | poor |
| Example 9 | | | | | |

### Examples 12 to 15 and Comparative Example 9

Optical recording media were individually produced in substantially the same manner as in Example 1 except that Ta2O5 films as an interface layer in Examples 12 to 15 and Comparative Example 9 having the respective thicknesses shown in Table 3 above were individually formed, and they were evaluated with respect to the overwrite properties.

From Table 3, the following findings are obtained.

In Examples 12 to 15, the Ta2O5 film as an interface layer has a thickness in the range of from 0 to 7 nm, and therefore 8× overwrite was possible up to 501 times of recording and the overwrite properties were excellent. Particularly, in Examples 13 and 14, the Ta2O5 film as an interface layer has a thickness in the range of from 1 to 4 nm, and therefore the overwrite properties were excellent. By contrast, in Comparative Example 9, the Ta2O5 film has a thickness of more than 7 nm and therefore the 8× overwrite properties were unsatisfactory.

The thicknesses of the recording layers in Examples 16 and 17 and Comparative Examples 10 and 11 and the results of the evaluation of the signal properties are shown in Table 4 below.

TABLE 4

| | Thickness | | | | |
|---|---|---|---|---|---|
| | (nm) | | | | |
| | Recording | Overwrite properties | | | |
| | film | DOW 0 | DOW 1 | DOW 10 | DOW 500 |
| Example 16 | 12 | excellent | good | good | good |
| Example 17 | 18 | excellent | good | excellent | good |
| Comparative | 10 | excellent | poor | good | poor |
| Example 10 | | | | | |
| Comparative | 20 | good | poor | good | poor |
| Example 11 | | | | | |

### Examples 16 and 17 and Comparative Examples 10 and 11

Optical recording media were individually produced in substantially the same manner as in Example 1 except that GaSnGeSb films as a recording layer in Examples 16 and 17 and Comparative Examples 10 and 111 having the respective thicknesses shown in Table 4 above were individually formed, and they were evaluated with respect to the overwrite properties.

From Table 4, the following findings are obtained.

In Examples 16 and 17, the GaSnGeSb film has a thickness in the range of from 12 to 18 nm, and therefore 8× overwrite was possible up to 501 times of recording. By contrast, in Comparative Examples 10 and 11, the GaSnGeSb film has a thickness of less than 12 nm or more than 18 nm and therefore the 8× overwrite properties were unsatisfactory.

The thicknesses of the interface layers in Comparative Examples 12 and 13 are shown in Table 5 below.

TABLE 5

| | Thickness (nm) | Overwrite properties | | | |
|---|---|---|---|---|---|
| | SiO₂ Film | DOW 0 | DOW 1 | DOW 10 | DOW 500 |
| Comparative | 2 | good | poor | good | poor |
| Example 12 | | | | | |
| Comparative | 4 | good | poor | poor | poor |
| Example 13 | | | | | |

### Comparative Examples 12 and 13

Optical recording media were individually produced in substantially the same manner as in Example 1 except that SiO2 films as an interface layer in Comparative Examples 12 and 13 having the respective thicknesses shown in Table 5 above were individually formed, and they were evaluated with respect to the overwrite properties.

From Table 5, the following findings are obtained.

In Comparative Examples 12 and 13, SiO2 is used as a material for the interface layer, and therefore the 8× overwrite properties were unsatisfactory.

The thicknesses of the interface layers in Comparative Examples 14 and 15 are shown in Table 6 below.

TABLE 6

| | Thickness (nm) | Overwrite properties | | | |
|---|---|---|---|---|---|
| | TiO₂ Film | DOW 0 | DOW 1 | DOW 10 | DOW 500 |
| Comparative | 2 | good | poor | good | poor |
| Example 14 | | | | | |
| Comparative | 4 | poor | poor | poor | poor |
| Example 15 | | | | | |

### Comparative Examples 14 and 15

Optical recording media were individually produced in substantially the same manner as in Example 1 except that TiO2 films as an interface layer in Comparative Examples 14 and 15 having the respective thicknesses shown in Table 6 above were individually formed, and they were evaluated with respect to the overwrite properties.

From Table 6, the following findings are obtained.

In Comparative Examples 14 and 15, TiO2 is used as a material for the interface layer, and therefore the 8× overwrite properties were unsatisfactory.

Hereinabove, the embodiments and Examples of the present application are described in detail, but the present application is not limited to the embodiments or Examples, and the present application can be changed or modified based on the technical concept of the present application.

For example, numbers or values mentioned in the above embodiments and Examples are merely examples, and, if necessary, numbers or values different from them may be used.

In the second embodiment, an example in which the upper dielectric layer 12 is composed of the first upper dielectric layer 12a and second upper dielectric layer 12b is described, but the upper dielectric layer 12 may be composed of two layers or more, for example, three dielectric layers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical recording medium comprising:
at least an upper dielectric layer, a recording layer, a lower dielectric layer, a sulfide-stain preventing layer, and a reflective layer formed on a substrate in this order in the direction of incidence of a recording or reading laser,
wherein said recording layer is composed of a material represented by the following general formula:
GaₓSn_{y}Ge_{z}Sb_{w}
wherein 0≦x≦7, 13≦y≦20, and 0.08≦z/w≦0.2,
wherein said lower dielectric layer is composed of a composite material of zinc sulfide and silicon oxide and has a thickness of 1 to 6 nm, and
wherein said reflective layer is composed of an Ag alloy and has a thickness of 160 nm or more.

2. The optical recording medium according to claim 1, wherein said recording layer has a thickness ranging from 12 to 18 nm.

3. The optical recording medium according to claim 1, further comprising a Ta oxide layer in contact with the surface of said recording layer on a side of incidence of a laser beam.

4. The optical recording medium according to claim 3, wherein said Ta oxide layer has a thickness ranging from 1 nm to 4 nm.

5. The optical recording medium according to claim 1, wherein said sulfide-stain preventing layer is composed of silicon nitride and is in contact with said reflective layer.

6. A method for producing an optical recording medium which includes at least an upper dielectric layer, a recording layer, a lower dielectric layer, a sulfide-stain preventing layer, and a reflective layer sequentially formed on a substrate in a direction of incidence of a recording or reading laser,
said method comprising the steps:
forming said recording layer composed of GaₓSn_{y}Ge_{z}Sb_{w} wherein 0≦x≦7, 13≦y≦20, and 0.08≦z/w≦0.2;
forming said lower dielectric layer, composed of a composite material of zinc sulfide and silicon oxide, having a thickness ranging from 1 nm to 6 nm; and
forming said reflective layer, composed of an Ag alloy, having a thickness of 160 nm or more.
